(19) United States
(12) Patent Application Publication
(10) Pub. No.: US 2014/0224896 A1
(43) Pub. Date: Aug. 14, 2014

(54) METHOD FOR REGULATING THE MASS FLOW OF SPREADING MATERIAL IN A DISC SPREADER

(71) Applicant: RAUCH Landmaschinenfabrik GmbH, Sinzheim (DE)

(72) Inventor: Michael LINZ, Buhl (DE)

(73) Assignee: RAUCH Landmaschinenfabrik GmbH, Sinzheim (DE)

(21) Appl. No.: 14/178,728

(22) Filed: Feb. 12, 2014

(30) Foreign Application Priority Data
Feb. 13, 2013 (DE) 10 2013 002 393.9

(51) Int. Cl. A01C 21/00

(52) U.S. Cl. CPC A01C 21/005
USPC 239/11

(57) ABSTRACT

A method for regulating the actual mass flow of spreading material of a regulated metering unit of a disc spreader with a distribution disc associated with the metering unit. A target mass flow of spreading material is determined depending on at least a plurality of spreading parameters and the target mass flow is provided as input to a computer-based regulating device as a reference value. A regulating mode of the regulating device the deviation of the actual mass flow of spreading material from the target mass flow is determined and an actuating variable representative of the opening position of the metering unit is generated depending on the actual revolution rate of the distribution disc or of the shaft in the drive train itself in order to readjust the metering unit to the target mass flow.

### CROSS REFERENCE TO RELATED APPLICATIONS

This application claims the benefit of priority under 35 U.S.C. §119 of German Patent Application DE 10 2013 002 393.9 filed Feb. 13, 2013, the entire contents of which are incorporated herein by reference.

### FIELD OF THE INVENTION

The present invention relates to a method for regulating the actual mass flow of spreading material of at least one regulated metering unit of a disc spreader with at least one distribution disc associated with the metering unit, wherein a target mass flow of spreading material depending on at least one parameter from the group

current vehicle speed of the disc spreader;

target spreading quantity per unit area; and

working width

is determined and said target mass flow is provided as input to a computer-based regulating device as a reference value, wherein on the one hand at least one sensor-determined controlled variable representative of the actual mass flow from the group

torque of at least one shaft in a drive train of the distribution disc;

torsion of at least one shaft in a drive train of the distribution disc;

pressure difference of a hydraulic motor used to drive the distribution disc; and

current drain of an electric motor used to drive the distribution disc

is also provided as input to the regulating device and on the other hand the sensor-determined actual revolution rate of the distribution disc or of at least one shaft in the drive train itself is provided as input to the regulating device, whereupon in a regulating mode of the regulating device the deviation of the actual mass flow of spreading material from the target mass flow of spreading material is determined and depending on the actual revolution rate of the distribution disc or of the shaft in the drive train itself an actuating variable representative of the opening position of the metering unit is generated in order to readjust the metering unit to the target mass flow.

The invention also relates to a disc spreader having at least one distribution disc, which can be set into rotation by a drive train of a drive, and having at least one metering unit controllable by a computer-controlled regulating device.

### BACKGROUND OF THE INVENTION

Such disc spreaders are especially widely used in the form of twin-disc fertilizer spreaders in agriculture for the distribution of spreading material such as mineral or organic fertilizer and similar, but also in the form of winter maintenance spreaders for the distribution of road salt and/or grit. Their advantages lie primarily in their simple operability and high efficiency at relatively low capital costs.

In order to provide the desired distribution of the spreading material on the soil, on the one hand with generic disc spreaders the metering of the mass flow of the spreading material to the distribution disc associated with a respective metering unit can be adjusted or controlled, on the other hand the distribution of the spreading material by the distribution disc(s) can be adjusted or controlled. For the latter case it is usual to provide adjustment means for adjusting the disc spreader to different working widths, spreading materials and/or types of distribution. In relation to the first-mentioned metering of the spreading material it has proved that a computer-based regulating device determines a target mass flow of spreading material to be distributed from one or especially a plurality of selectable parameters, such as the current vehicle speed, the target spreading quantity per unit area, the desired working width etc., and regulates the metering unit according to the target mass flow determined in this way, which can take place especially using at least one or a plurality of characteristic curves that are placed in the computer and that describe the correlation of the respective parameter with the associated mass flow of spreading material (DE 198 25 917 A1, EP 0 963 690 A1). In this connection it should be noted that the term “characteristic curve” does not necessarily refer to a straight line, but to a practically arbitrary functional dependency, which obviously can also be implemented in the form of a curve.

Moreover, it is known to use so-called characteristic fields instead of characteristic curves, the characteristic fields being stored in the computer or in a database connected to the computer and e.g. comprising a plurality of groups of values, which represent the dependency of the controlled variable representative of the actual mass flow (such as the sensor-recorded torque of a shaft in the drive train of the distribution disc or its torsion or—in the case of a hydraulic drive of the distribution disc—possibly also the pressure difference of a hydraulic motor used for driving the distribution disc or—in the case of an electric drive of the distribution disc—possibly also the current drain of an electric motor used to drive the distribution disc) on the mass flow for different revolution rates of the distribution disc (EP 0 945 548 A2, EP 1 008 288 A2).

Furthermore, physical properties dependent on the respective spreading material, which especially describe its fluid properties or flow properties and which are referred to as so-called “flow factors”, can be entered as further parameters, wherein such a flow factor describes the correlation between the mass flow and the actuator position dependent on the fluid properties of the spreading material during metering. By this means it is possible, especially at the start of the spreading operation, to determine with yet greater accuracy the characteristic curves that correlate said selectable parameter with the target mass flow to be determined therefrom, taking into account the fluid properties of the spreading material used.

As for the metering of spreading material, in particular two different versions have become accepted for measuring and regulating the actual mass flow of spreading material:

According to a first variant for measuring and regulating the actual mass flow of spreading material imparted to the spreader disc, the entire spreading material container of the disc spreader is continuously weighed by means of weighing cells, i.e. even while traveling, so that the actual mass flow of the spreading material can be calculated from the determined weight loss per unit time (EP 0 982 571 A2). The universal applicability of such a measurement arrangement independently of a hydraulic or mechanical drive of the distribution disc is especially of advantage here. It has proved to be disadvantageous on the one hand that with such a weighing technique only the entire mass flow of spreading material can be determined, which in the case of a twin disc spreader, with which the distribution discs frequently have to be supplied by different mass flows of spreading material (if e.g. a different spreading width is required on both sides), makes it impossible to determine the individual mass flows (per distribution disc). On the other hand, the system equipped with weighing cells is relatively sluggish, because the mass of spreading material dispensed per unit time is very small in relation to the total mass of the spreading material container and therefore averaging of the measurement values determined by the weighing cells is necessary over a relatively long period. This is increasingly problematic with more vibration-intensive travel of the disc spreader on an uneven surface.

According to a second variant, for measuring and regulating the mass flow of spreading material the torque in a drive train of a drive of the distribution disc or of each distribution disc, which is representative of said mass flow, is determined owing to the fact that the spreading material incident on the distribution disc(s) is accelerated away from the disc by means of its spreading blades. DE 198 25 917 A1 discloses a generic centrifugal spreader for distributing spreading material with a variable working width and at variable vehicle speed, which comprises a reservoir container, one or two rotationally driven distribution disc(s) with spreading blades, means for adjusting the spreader to different working widths and types of fertilizer and an adjustable metering unit, which can be controlled by a computer-based regulating device. The vehicle speed, the target spreading quantity per unit area and the working width can be provided as input into the computer. In addition, for each adjustment of the adjustment means characteristic curves for the relationship between the torque of the distribution disc and the mass flow as a function of the revolution rate, including a no-load characteristic curve for zero mass flow, are placed in the computer. The torque and the revolution rate of the rotary drive are recorded by means of a sensor in each case. The output variable of the torque sensor increases with increasing actual mass flow. Following matching to the target mass flow with simultaneous compensation of any revolution rate fluctuations, the deviation is used as an actuating variable for the metering unit. Whereas for a hydraulic drive of the distribution disc(s) the pressure drop of the hydraulic motor is determined by sensor, for an electrical drive of the distribution disc(s) the current drain of the electric motor is recorded by sensor. In the case of a mechanical drive of the distribution disc(s), strain gauges and/or slip contacts are used.

EP 0 963 690 A1, which claims the priority of the above-mentioned DE 198 25 917 A1, discloses a similar centrifugal spreader, wherein for determining the torque of the distribution disc in the case of a mechanical drive of the same, two incremental encoders disposed at a distance apart and associated with pulse pickups are further provided on a transverse shaft that drives the respective vertical shafts carrying the distribution discs by means of bevel gears, in order to record the torsion of the shaft or the torque representative thereof. During no-load operation, i.e. without load on the distribution disc with the metering unit closed, there is consequently on the one hand a measure of the no-load torque, whereas on the other hand in the case of a load on the distribution disc with a target mass flow of spreading material the pulse pickup detects a phase shift that is representative of the total torque resulting from the subtraction of the no-load torque from the actual mass flow torque. In order to only record the actual torque caused by the mass flow of spreading material that is incident on the distribution disc fitted with spreading blades, at regular time intervals—especially when the disc spreader is turning at the headland and the metering units must be closed in any case—repeated no-load torque measurements can be performed (with the metering unit closed), in order to determine a highly accurate torque that is only caused by the spreading material by means of the above-mentioned subtraction method.

The same applies to the device for recording the torque in a drive train of the distribution disc of a disc spreader known from DE 101 54 737 C1, which provides measurement by sensor at a narrowed section of the transverse shaft driving the distribution discs by means of bevel gears, in order to increase the torsion under load or the measurement accuracy. However, this does not result in significantly improved measurement accuracy and does not enable the system to record especially small mass flows (or small resulting bending torques) with sufficient accuracy, because the narrowed shaft section vibrates to a greater extent. In addition, overload protection in the form of a supporting tube connecting the opposite ends of the narrowed shaft section is necessary in order to absorb the maximum value of the torque that mainly occurs when switching on the drive and to protect the narrowed shaft section against damage.

DE 10 2012 002 585 A1, which had not yet been published at the priority date of the present patent application discloses a similar method for regulating the actual mass flow of a generic disc spreader, with which the torsion of the shaft carrying the distribution disc that is caused by the acting torque is used as a controlled variable representative of the actual mass flow, wherein the torsion is recorded especially by means of a contactless sensor, such as a fluxgate magnetometer.

Whereas the previously described method for regulating the mass flow for single and twin disc spreaders fitted with distribution discs has been proved, there is a disadvantage in that the controlled variable representative of the actual mass flow is highly dependent on the revolution rate of the distribution disc, and is indeed independent of whether the sensor-detected torque or the torsion of a shaft in the drive train of the distribution disc, the pressure difference of a hydraulic motor used to drive the distribution disc or the current drain of an electric motor used to drive the distribution disc is used as a controlled variable. This is primarily because the load caused by the spreading material incident on the distribution disc fitted with spreading blades is in most cases small compared with the load that occurs in the event of a change of the revolution rate of the distribution disc and which especially contains inertial forces. With known regulating devices according to the prior art, it is assumed that the drive revolution rate of the distribution disc can indeed be adjusted according to the desired revolution rate that e.g. is suitable for achieving the desired working width, but it is held constant during the spreading process. This is also substantially possible in the case of a hydraulic or electrical drive of the distribution disc, wherein in this respect the regulating device can also carry out the function of revolution rate regulation. Nevertheless, load fluctuations can also occur with said types of drive for the distribution disc, which result in a variation of the revolution rate and which can be caused e.g. by variations of the resistance in the drive train of the distribution disc (e.g. resulting from temperature-dependent oil viscosity, bearing resistance and/or internal stresses). Periodic no-load measurements with the unloaded distribution disc (the metering unit is closed) of the above-mentioned type are in most cases largely able to compensate for such effects, but nevertheless inaccuracies can occur in the case of changes in revolution rate. This is particularly problematic, however, in the case of a mechanical drive of the distribution disc, with which a coupling element of the drive train of the distribution disc is connected to the power take-off shaft of a tractor machine, such as a tractor, in order to set the distribution disc in rotation. In this case the regulating device cannot take part in the control of the revolution rate of the distribution disc and the same consequently cannot be held constant during the spreading process. Rather, the mechanical drive (on the part of the tractor machine) is frequently accelerated or decelerated during the spreading process according to experience—whether intentionally or unintentionally, such as e.g. as a result of an adjustment of the speed of travel while traveling from the field into the headland or from the headland into the field or when traveling up or down on a slope. Consequently, because of variation of the revolution rate of the distribution disc, an additional positive or negative torque acts on the drive train of the distribution disc, which causes the regulating device to open or close the metering unit, although the actual torque acting on the distribution disc, which is only caused by the spreading material incident (which, as stated, is nevertheless small), remains unchanged in principle, which the regulating device cannot “know” of course, because it must assume the sensor-detected torque or the torsion of the shaft in the drive train of the distribution disc. The same applies for the case in which the control device receives a pressure or current “step” by means of a pressure sensor of a hydraulic motor or by means of a current sensor of an electric motor for driving the distribution disc, resulting not from a variation of the mass flow of spreading material incident on the distribution disc, but rather from a temporary variation (which is unintended) of the revolution rate.

This problem is graphically illustrated in the curve shown in FIG. 1. The lower curve in FIG. 1 shows the variation of the revolution rate n over time t during a phase of the spreading process. The revolution rate n is substantially constant here, but decreases at a point in time t₁, whereupon it rises again in order to reach the desired, constant value again at a point in time t₂. This can typically be the case if the distribution disc of the disc spreader comprises a mechanical drive coupled to the power take-off shaft of the tractor machine and the farmer in the tractor machine drives away over a hill. The upper curves in FIG. 1 show on the one hand the variation of the target mass flow \dot{m}ₙₒₘᵢₙₐₗ as an actuating variable over time t, which in the present case is approximately constant and has been entered into the control device as a function of the vehicle speed, the desired target spreading quantity per unit area and the desired working width. On the other hand, the upper curves in FIG. 1 show the variation of the actuating variable y, which can correspond e.g. to the position of the actuator of a metering disc of the metering unit, as well as the actual mass flow \dot{m}_{actual} as a controlled variable over time t (grey curve). As can be seen from FIG. 1, the actuating variable y rises steeply at point in time t₁, at which the revolution rate reduces, because it suggests to the regulating device that the torque acting on the shaft in the drive train of the distribution disc—caused by the mass flow of spreading material incident on the distribution disc—had dropped sharply, whereupon the control device increases the actuating variable y in order to compensate for the supposedly too low mass flow of spreading material by opening the metering unit. As a result the actual mass flow \dot{m}_{actual} increases strongly as the controlled variable and strong local overfertilization occurs during the revolution rate change, which should be avoided both for reasons of plant protection and also on environmental safety grounds as a well as not least for economic reasons. After a constant revolution rate of the distribution disc is again reached at a point in time t₂, the regulating device again regulates the actuating variable y and hence the actual mass flow \dot{m}_{actual} as the controlled variable—after a certain adjustment phase following at the point in time t₂, again as provided. Accordingly, e.g. in the case of a temporary increase of the revolution rate of the distribution disc (not shown), a local overfertilization occurs, which of course should also be avoided.

Corresponding problems of local excessive or too low metering of the spreading material can occur if a minimum signal-to-noise ratio necessary for regulation of the sensor-detected controlled variable (torque or torsion of the shaft disposed in a drive train of the distribution disc, pressure difference of a hydraulic motor for driving the distribution disc or current difference of an electric motor for driving the distribution disc) cannot be guaranteed, as can especially be the case in the event of a very small selected target mass flow as the actuating variable. A counterproductive opening or closing and hence e.g. a local overfertilization or underfertilization can also occur here if the regulating device controls the metering unit up or down because of supposed actual mass flows, which, however, are within the background noise, although in reality there is no reason for this. The latter problem is independent of the particular drive of the distribution disc of the disc spreader.

### SUMMARY OF THE INVENTION

An object of the invention is to develop a generic method for controlling the actual mass flow of spreading material for a disc spreader such that an excessive or too low amount of spreading material does not occur, or at least occurs to a significantly lower extent compared to the prior art, both during intended or unintended revolution rate changes of the distribution disc and also for the case in which the regulating device receives a controlled variable lying below a minimum of the signal-to-noise ratio. It is further aimed at a disc spreader of the above-mentioned type suitable for performing such a method.

In terms of method, this object is achieved by a method of the above-mentioned type, by which

while a maximum value of changes of the sensor-determined revolution rate of the distribution discs or of the shaft in the drive train itself is exceeded

and/or

while the signal-to-noise ratio of the sensor-determined controlled variable representative of the actual mass flow is below a minimum value

the regulating device

is set into a control mode or

activates a control mode of a control device,

wherein in the control mode an actuating variable representative of the opening position of the metering unit is generated independently of the sensor-determined controlled variable that is representative of the actual mass flow in order to control the metering unit of the distribution disc independently of said controlled variable.

With a disc spreader of the above-mentioned type, to achieve said object the invention provides that the regulating device is designed to perform a method of the above-mentioned type.

The invention consequently also provides, in addition to the known regulation of the actual mass flow of spreading material, temporary control of the actual mass flow, which takes over from regulation while a maximum value of changes of the sensor-determined revolution rate of the distribution disc or of the shaft in the drive train itself is being exceeded and/or while it is being determined that the signal-to-noise ratio of the sensor-determined controlled variable that is representative of the actual mass flow is below a minimum value, so that sometimes substantial errors that otherwise occur in such operating phases are avoided. The regulating device can hereby be designed such that it can either be operated both in the known regulating mode and also in the control mode provided according to the invention, or in the case of one of the above two operating states the regulating device activates an additionally provided control device and itself turns off the regulation of the actual mass flow during said operating states. The method according to the invention can thereby be used independently of the respective drive of the distribution disc of the disc spreader (whether it is hydraulic, electric or especially even mechanical) as well as independently of the sensor-recorded controlled variable that is representative of the actual mass flow, which can be recorded with any sensors that are known from the prior art. The latter may additionally also record the revolution rate of the distribution disc or of the shaft of the drive train itself, or separate sensors can be provided for this purpose, which are associated with at least one shaft in the drive train of the distribution disc and can also be disposed e.g. in the area of the power take-off shaft input, as is known with mechanical drives of the distribution disc. In this connection it should be noted that the “shaft in the drive train of the distribution disc” within the scope of the invention can also include the power take-off shaft of a tractor machine such as a tractor connected to the drive train in the case of a mechanical drive of the distribution disc(s) of the disc spreader, wherein the revolution rate of the power take-off shaft can readily be converted into the revolution rate of the distribution disc(s) if it is connected downstream of a gearbox and if the gear ratio (up or down) of said gearbox is known.

According to a first, very simple and inexpensive exemplary embodiment it can be provided that at least one of the last actuating variables representative of the opening position of the metering unit is stored in the regulating mode and said actuating variable is held constant in the subsequent control mode. Consequently, in the control mode the actuating variable representative of the opening position of the metering unit, such as e.g. the actuator position of a sliding metering element of the metering unit, is controlled to a constant value, which preferably corresponds to the last value or to an average value of the last values of said actuating variable in the preceding regulating mode. In this connection it is consequently possible that

the last actuating variable representative of the opening position of the metering unit or

an average value over a plurality of the last actuating variables representative of the opening position of the metering unit

is stored in the regulating mode and used for the control mode. The latter embodiment also prevents a random “outlier” of the actuating variable representative of the opening position of the metering unit being used for the control mode by averaging a number of actual values and inputting the average value into the control mode.

According to a second, by contrast further developed exemplary embodiment, it can be provided that the actuating variable representative of the opening position of the metering unit is generated in the control mode as a function of a value representative of the physical properties of the respective spreading material, especially its fluid properties. The advantage of said second exemplary embodiment is that it takes account of the physical properties of the spreading material, such as preferably at least its fluid properties or flow behavior, which can especially be described by the so-called flow factor (see below), wherein such a flow factor can be obtained e.g. from a spreading table of the particular spreading material used.

A design that comes particularly close to reality and is consequently particularly preferred can provide in this connection that at least one of the last values representative of the physical properties of the spreading material, especially its fluid properties, is stored in the regulating mode and the actuating variable representative of the opening position of the metering unit is generated in the subsequent control mode depending on said stored value. Consequently, the actual (current) fluid properties of the spreading material are taken into account not only in the regulating mode but also during the control mode, which because of external effects, such as moisture, ingress of foreign matter etc., can be subjected to not inconsiderable fluctuations. Also in relation to the second exemplary embodiment it is obvious that

the last value representative of the physical properties of the spreading material, especially its fluid properties, such as e.g. the flow factor or its reciprocal value (see below), or

an average value over a number of the latter values representative of the physical properties of the spreading material, especially its fluid properties, such as e.g. the flow factors or their reciprocal values (see below)

are stored in the regulating mode and used for the control mode. The latter embodiment also prevents a random “outlier” of the value representative of the fluid properties of the spreading material (e.g. because of an impurity of the spreading material, such as a stone, moisture entrapment or similar) from being used for the control mode by averaging a number of actual values and inputting the average value in the control mode.

Taking the fluid properties of the spreading material into account also especially makes it possible that the actuating variable representative of the opening position of the metering unit can also be generated depending on the target mass flow acting as a reference value, so that the target mass flow, if desired, can also be changed during the control mode and because of the known fluid properties nevertheless a very realistic value representative of the opening position of the metering unit can be obtained. If, moreover, as mentioned above, the last value or values representative of the physical properties of the spreading material, especially of its fluid properties or flow properties, is or are stored in the regulating mode and an actuating variable representative of the opening position of the metering unit is generated depending on said stored value and depending on the target mass flow used as a reference value, but independently of the sensor-determined controlled variable that is representative of the actual mass flow, the metering unit of the distribution disc can consequently be controlled—independently of said controlled variable—in a manner very close to reality. In this connection it should be mentioned again that the so-called flow factors, which describe the fluid properties or flow properties of the spreading material, are basically taken from suitable spreading tables and—e.g. to obtain an initial value for regulation—can be provided as input into the regulating device (EP 0 674 831 A1), but such flow factors can be subject to significant fluctuations and cannot just differ significantly from each other from charge to charge of the same type of spreading material, but can also vary markedly with time, such as especially in the case of contact with moisture of normally hygroscopic mineral fertilizer or even road salt. However, the invention enables the storage of a representative value for the fluid properties of the spreading material obtained during regulation, i.e. already adjusted, and consequently “bridges” the control phase with a currently correct value, which accurately represents the current physical spreading material properties. Any sudden changes of the actuating variable, such as e.g. of the actuator position of a sliding metering element of the metering unit, and sudden changes of the actual mass flow caused thereby, which result in a temporary local overfertilization or underfertilization, are therefore reliably prevented according to the invention during the transition from the regulating mode into the control mode.

In an advantageous embodiment it can thereby be provided that the value representative of the physical property of the spreading material is the reciprocal value of the flow factor, which is defined by the quotient of the target mass flow acting as a reference value divided by the actuating variable representative of the opening position of the metering unit, such as e.g. the actuator position of a sliding metering element of the metering unit. The flow factor is consequently preferably input directly in the control mode.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a graphic view of a conventional technique;

FIG. 2 is a graphic view of a revolution rate change of a distribution disc in a control mode compared to a regulating mode taking place at a constant revolution rate;

FIG. 3 is a graphic view of the effect of initializing a regulating mode of the invention following a preceding regulating mode and following bridging of a distribution disc revolution rate change in a control mode;

FIG. 4 is a schematic view of a first embodiment of a disc spreader of the present invention;

FIG. 5 is a schematic of a second embodiment of a disc spreader of the present invention;

FIG. 6 is a schematic view of a third embodiment of a disc spreader of the present invention; and

FIG. 7 is a schematic view of a fourth embodiment of a disc spreader of the present invention.

### DESCRIPTION OF THE PREFERRED EMBODIMENTS

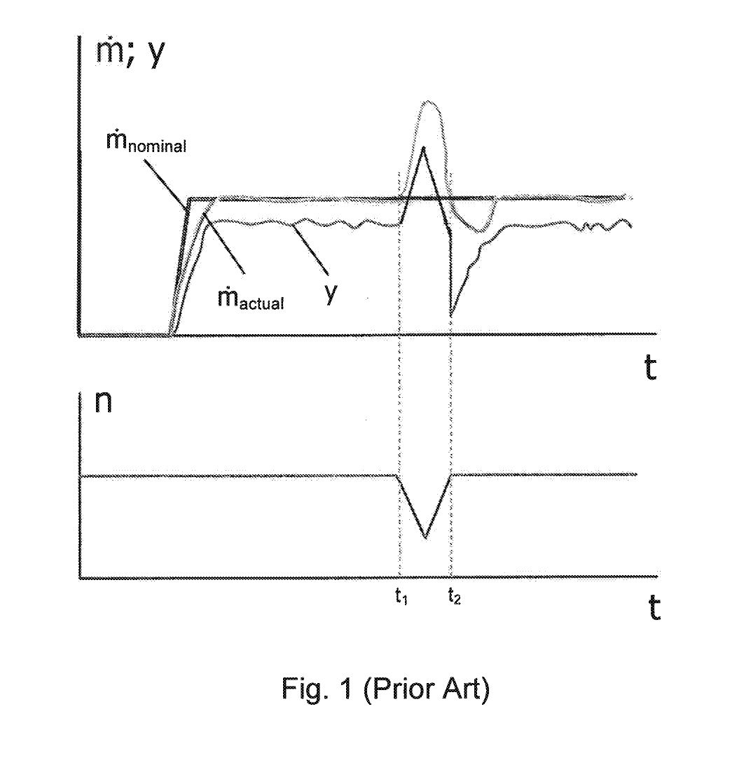

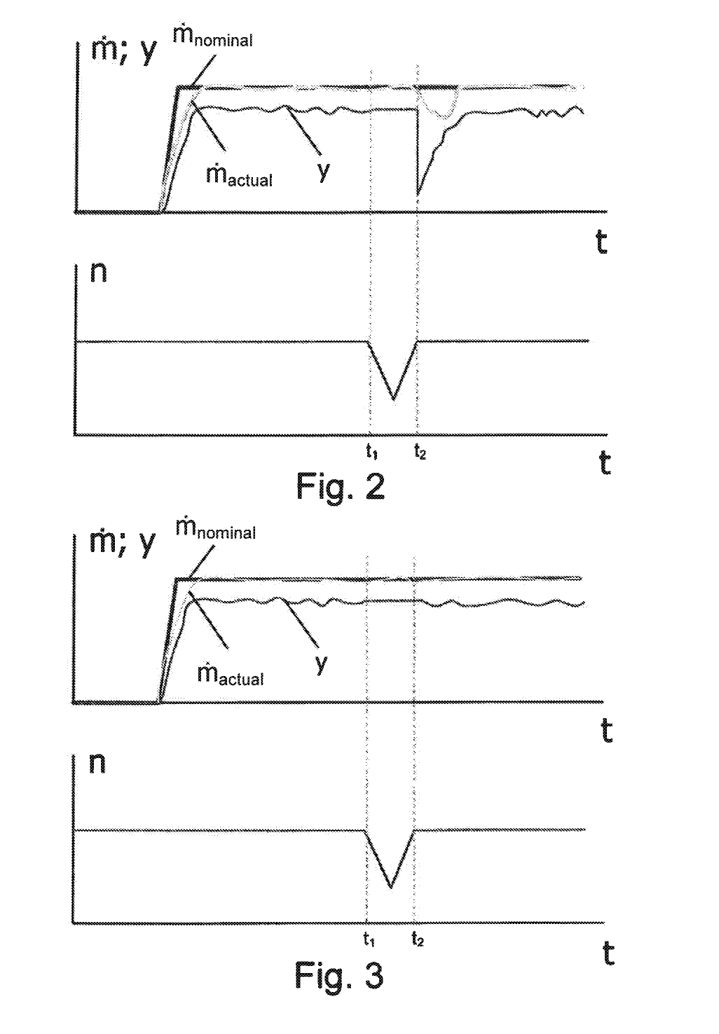

Referring to the drawings in particular, in FIG. 2 the effect according to the invention of using the bridging of a revolution rate change of the distribution disc in the control mode compared to the regulating mode taking place at constant revolution rate is illustrated graphically. The lower curve in FIG. 2 shows by analogy to FIG. 1 (see above) the variation of the revolution rate n over time t during a phase of the spreading process. The revolution rate n is again substantially constant, but decreases at a point in time t₁, whereupon it rises again in order to reach the desired constant value again at a point in time t₂. In this respect this situation corresponds exactly to the situation graphically reproduced in FIG. 1. The upper curves in FIG. 2 again show on the one hand the variation of the target mass flow \dot{m}ₙₒₘᵢₙₐₗ as a reference value over time t, which by analogy to FIG. 1 is approximately constant and was input to the regulating device depending on the vehicle speed, the desired target spreading quantity per unit area and the desired working width. On the other hand, the upper curves in FIG. 2 show—again by analogy to FIG. 1—the variation of the actuating variable y, which e.g. can correspond to the position of the actuator of a sliding metering element of the metering unit, as well as the \dot{m}_{actual} mass flow actual as the controlled variable over time t (grey curve).

As can be seen from FIG. 2, the regulating mode is suspended at point in time t₁, at which the revolution rate reduces, and the control mode starts, wherein especially as a result of this at least one of the last values of the control mode representative of the current fluid properties of the spreading material is stored and the control mode uses said representative value, a smooth transition of the actuating variable y and hence of the actual mass flow \dot{m}_{actual} is ensured, wherein the actuating variable y (that is e.g. the actuator position of the sliding metering element of the metering unit) and hence the actual mass flow \dot{m}_{actual} can especially be held approximately constant, as long as the revolution rate n of the distribution disc changes to the extent that regulation would lead to unrealistic results for the reasons explained above. Underfertilization or overfertilization during time t₁<t<t₂, in which changes of the revolution rate n of the distribution disc occur, is reliably avoided in this way, which of course similarly applies if the revolution rate n rises more or less abruptly (not shown). If the revolution rate n of the distribution disc again reaches a constant value or falls below a predetermined Maximum value of a just tolerable change at point in time t₂, the control mode is deactivated again and the regulating mode is started again, wherein after a certain settling time (t>t₂) the same (regulation) situation applies as prior to the revolution rate change (t<t₁).

The invention also makes it possible that the control of the metering unit in the control mode takes place independently of the sensor-determined revolution rate of the distribution disc or of the shaft in the drive train itself. The control mode can consequently also be based on a very simple algorithm if it takes into account both the—possibly variable—target mass flow of spreading material and also the (previously input or especially obtained from the preceding regulating mode) flow factor of the spreading material, said algorithm requiring, besides the target mass flow as a reference value, only the current value, especially taken from the regulating mode, which represents the physical (fluid) properties of the spreading material. Nevertheless, the revolution rate of the distribution disc or of the shaft in the drive train itself must of course be detected by sensor continuously and/or at periodic time intervals or the signal-to-noise ratio of the sensor-recorded controlled variable representative of the actual mass flow must be monitored continuously and/or at periodic time intervals in order to be able to determine the end of the control mode and to initiate the regulating mode again.

According to one advantageous embodiment, it can also be provided that the control of the metering unit in the control mode takes place depending on the reciprocal values at least of one of the last flow factors in the regulating mode multiplied by the target mass flow used as the reference value.

By way of example, a control formula as a function of time t is illustrated below, such as can form the basis of the control mode (from point in time t₁ until point in time t₂ according to FIG. 2):

$$ys ( t ) = \frac{{y}_{R} ( {t}_{1} - 1 )}{w ( {t}_{1} - 1 )} * w ( t )$$

### Where:

ys(t): is the actuating variable during the control mode, such as e.g. the actuator position of a sliding metering element of the metering unit, as a function of time t;
y_{R}(t₁−1): is the last actuating variable (e.g. actuator position of the metering unit) of the regulating mode at the point in time immediately before t₁ (see FIG. 2), i.e. immediately before the changeover to the control mode;
w(t₁−1): is the last reference value (target mass flow \dot{m}ₙₒₘᵢₙₐₗ) of the regulating mode at the point in time immediately before t₁ (see FIG. 2), i.e. immediately before the changeover to the control mode; and
w(t): is the reference value (target mass flow \dot{m}ₙₒₘᵢₙₐₗ) as a function of t, as previously input to the regulating device.
   The term
   consequently corresponds to the reciprocal value of the flow factor of the spreading material, which is defined by the quotient of the target mass flow \dot{m}ₙₒₘᵢₙₐₗ used as the reference value w divided by the actuating variable y representative of the opening position of the metering unit, at the point in time immediately before t₁ (see FIG. 2), i.e. at the end of the regulating mode immediately before the changeover to the control mode. As mentioned above, instead of the last value at the point in time (t₁−1), the average value over a number of last values of the regulating mode can also be taken into account.

$$\frac{{y}_{R} ( {t}_{1} - 1 )}{w ( {t}_{1} - 1 )}$$

Regarding the regulating mode, according to one exemplary embodiment it can be provided that the regulation of the actual mass flow in the regulating mode takes place using a plurality of characteristic curves stored in the regulating device or in a memory associated therewith, which describe the dependency of the actual mass flow on the respective sensor-determined controlled variable representative of the actual mass flow from the group

torque of at least one shaft in a drive train of the distribution disc;

torsion of at least one shaft in a drive train of the distribution disc;

pressure difference of a hydraulic motor used for driving the distribution disc; and

current drain of an electric motor used for driving the distribution disc

for different revolution rates or ranges of revolution rate of the distribution disc or of the shaft in the drive train itself. Each characteristic curve placed in the regulating device, which—as mentioned above—can be constructed e.g. in the manner of a linear equation, but which can also describe any other functional dependency of the actual mass flow of the sensor-determined actuating variable, e.g. in the form of a curve, consequently relates to a certain revolution rate so that a family of characteristic curves is placed in the regulating device, wherein the actual revolution rate of the distribution disc or of the shaft in the drive train itself is associated with the respective corresponding characteristic curve.

According to an alternative exemplary embodiment, it can be provided that the regulation of the actual mass flow in the regulating mode is carried out using at least one mathematical function, which describes the dependency of the actual mass flow both on the respective sensor-determined actuating variable representative of the actual mass flow from the group

torque of at least one shaft in a drive train of the distribution disc;

torsion of at least one shaft in a drive train of the distribution disc;

pressure difference of a hydraulic motor used to drive the distribution disc; and

current drain of an electric motor used to drive the distribution disc

and also on the revolution rate of the distribution disc or of the shaft in the drive train itself. In this case the revolution rate is consequently input into the mathematical function forming the characteristic line or curve and the latter can be used universally for a plurality of revolution rates of the distribution disc or of the shaft in its drive train.

Moreover, it is obviously conceivable to use a characteristic field or characteristic diagram instead of characteristics or characteristic curves, as already mentioned and as known as such in the prior art referred to therein.

Moreover, in another advantageous embodiment it can also be provided that the controlled variable representative of the actual mass flow can be selected from the group

torque of at least one shaft in a drive train of the distribution disc; and

torsion of at least one shaft in a drive train of the distribution disc,

so that the method according to the invention can be used for all generic disc spreaders irrespective of their distribution disc drives—whether mechanical, hydraulic or electrical. In this connection it has, moreover, proved advantageous if the torque and/or the torsion of the shaft in the drive train of the distribution disc is determined contactlessly, especially by means of a magnetostriction sensor. E.g. in this connection fluxgate magnetometers are mentioned, as disclosed in the above-mentioned DE 10 2012 002 585 A1, which had not yet been published at the priority date of the present patent application, wherein the disclosure of DE 10 2012 002 585 A1 is hereby incorporated by reference.

Moreover, it can be advantageous that the controlled variable representative of the actual mass flow is determined by sensor on the one hand, especially at periodic time intervals, during no-load operation with the metering unit closed and consequently with an unloaded distribution disc, and on the other hand with the distribution disc under load with the actual mass flow, wherein the value determined during no-load operation is subtracted from the total value determined under load in order to determine the difference value caused by the actual mass flow of the spreading material alone, wherein said difference value is input to the regulating device as the at least one sensor-determined controlled variable representative of the actual mass flow from the group

torque of at least one shaft in a drive train of the distribution disc;

torsion of at least one shaft in a drive train of the distribution disc;

pressure difference of a hydraulic motor used to drive the distribution disc; and

current drain of an electric motor used to drive the distribution disc.

If the disc spreader is an agricultural spreading machine, the no-load measurements of the controlled variable can especially take place while moving through the headland, whilst the metering unit(s) has or have to be closed in any case and consequently no spreading material is incident on the distribution disc(s).

As already indicated, it is obviously advantageous if the regulating device

is set to the regulating mode again or

deactivates the control mode of the control device,

once

the, especially predeterminable, maximum value of changes of the sensor-determined revolution rate of the distribution disc or of the shaft in the drive train itself is reached again or the change falls below the same

and/or

the, especially predeterminable, minimum signal-to-noise ratio of the sensor-determined controlled variable representative of the actual mass flow of spreading material is reached again or exceeded. This corresponds to the exemplary situation after the point in time t2 according to FIG. 1, in which the revolution rate n of the distribution disc is (just) constant again and the phase of the control mode (t₁<t<t₂) has ended in order to initiate a renewed phase of the regulating mode (t>t₂). The control mode is consequently only used for bridging operating phases in which the regulating mode would lead to unrealistic mass flows of spreading material because of variations of the revolution rate of the distribution disc or of the shaft in its drive train and/or because of such a small, sensor-recorded actual mass flow that the signal is in the background noise, wherein otherwise the regulating mode represents the method of choice.

In this connection, according to a particularly advantageous development of the method according to the invention it can be provided that

after resetting the regulating device to the regulating mode

or

following deactivation of the control device

at least for the first determination of the actuating variable representative of the opening position of the metering unit in the regulating mode, an integrating component of the regulation means, which integrates the deviation of the actual mass flow of spreading material from the target mass flow of spreading material over time, is set to zero.

Moreover, according to such a particularly advantageous development of the method according to the invention, it can alternatively or preferably be cumulatively provided that at least one of the last actuating variables representative of the opening position of the metering unit can be stored in the control mode and said stored actuating variable

after resetting the regulating device to the regulating mode or

following deactivation of the control device

is added especially as a summary component for determining the actuating variable representative of the opening position of the metering unit in the regulating mode of the regulation. Similarly to when referring to the control mode (see above), it can also be of advantage here if the last actuating variable in the control mode or an average value over a number of last actuating variables in the control mode is stored and used for the regulating mode. If in the control mode a constant actuating variable is generated, which e.g. arises from a constant target mass flow and a constant flow factor of the spreading material during the control phase, then of course any actuating variable of the control mode can be stored and taken into account for the subsequently occurring regulating mode.

Said measures make it especially possible to associate the settling phase at the start of the regulating mode, i.e. after the end of a temporary control mode, with a representative starting value taken from the control mode, so that initial deflections during the settling phase can be prevented and both too low and also excessive spreading of spreading material at the start of the regulating mode can also be prevented.

In each case it can be of advantage if in the regulating mode a value representative of the deviation of the actual mass flow of spreading material from the target mass flow of spreading material at the point in time during or immediately

after resetting the regulating device to the regulating mode or

after deactivation of the control device

is subtracted from the summary component of the stored actuating variable from the control mode that is representative of the opening position of the metering unit and that was added to the control means. The latter can especially depend on the regulating deviation, i.e. on the difference of the actual mass flow from the target mass flow at the point in time during or immediately after the start of the regulating mode, so that the summary component and the value to be subtracted therefrom essentially cancel with increasing duration of the regulating mode, i.e. when the actual mass flow very closely approaches the target mass flow.

An exemplary embodiment of such a summary component of regulation, including a value to be subtracted therefrom, is reproduced below by way of example:

y_{Radaptiv}=y_{S}(t₂)−Kₚ*x_{d}(t₂)−K_{D}*x_{d}(t₂)

### Where:

y_{Radaptiv}: is a general term of a component of the actuating variable y, such as e.g. the actuator position of a sliding metering element of the metering unit, of a regulating algorithm (suffix “R”; see below);
y₂(t₂): is a summary component of the general term y_{Radaptiv} for the actuating variable y, which describes the last actuating variable y representative of the opening position of the metering unit (such as e.g. the actuator position of its sliding metering element) in the preceding control mode (suffix “S”) at point in time t2, i.e. immediately before the changeover to the regulating mode, (see FIG. 3 in combination with the explanations further below) and which is stored. y₂(t₂) consequently corresponds to the last actuating variable in the control mode;
Kₚ*x_{d}(t₂): is a first value to be subtracted from the summary component y₂(t₂), which is representative of the regulating deviation x_{d} (i.e. of the deviation of the actual mass flow \dot{m}_{actual} from the target mass flow \dot{m}ₙₒₘᵢₙₐₗ) at point in time t₂, i.e. immediately before the changeover to the regulating mode (see FIG. 3 in combination with the explanations further below), wherein Kₚ is a first constant; and
K_{D}*X_{d}(t₂): is a second value to be subtracted from the summary component y₂(t₂), which is representative of the first derivative of the regulating deviation x_{d} (i.e. of the deviation of the actual mass flow \dot{m}_{actual} from the target mass flow \dot{m}ₙₒₘᵢₙₐₗ) at point in time t₂, i.e. immediately before the changeover to the regulating mode (see FIG. 3 in combination with the explanations further below), wherein K_{D} is a second constant.

A (whole) regulating algorithm for the actuating variable y_{R}(t), such as e.g. the actuator position of a sliding metering element of the metering unit, during the control mode as a function of time t can e.g. be expressed here as follows:

y_{R}(t)=Kₚ*x_{d}(t)+K_{D}*x_{d}(t)+K₁*∫x_{d}*dt+y_{Radaptiv}

### Where:

Kₚ; K_{D}; K₁: are constants;
x_{d}(t): is the regulating deviation, i.e. the deviation of the actual mass flow \dot{m}_{actual} from the target mass flow \dot{m}ₙₒₘᵢₙₐₗ as a function of time t;
\dot{x}(d(t): first derivative of the regulating deviation, i.e. the deviation of the actual mass flow \dot{m}_{actual} from the target mass flow \dot{m}ₙₒₘᵢₙₐₗ against time t;
∫x_{d}*dt integrating component of the regulating algorithm, which describes the integral of the regulating deviation, i.e. the deviation of the actual mass flow \dot{m}_{actual} from the target mass flow \dot{m}ₙₒₘᵢₙₐₗ after time t; and
y_{Radaptiv}: general term of a component of the actuating variable y, such as e.g. the actuator position of a sliding metering element of the metering unit, of the regulating algorithm, which takes into account the last actuating variable y of the preceding control mode (see above).

In FIG. 3 the effect of the initialization of the regulating mode according to the invention following a preceding regulating mode and following bridging of a distribution disc revolution rate change in the control mode is graphically illustrated. The lower curve in FIG. 3 shows by analogy to FIGS. 1 and 2 (see above) the variation of the revolution rate n over time t during a phase of the spreading process. The revolution rate n is again substantially constant, but decreases at a point in time t₁, whereupon it rises again in order to again reach the desired, constant value at a point in time t₂. This situation corresponds in this respect exactly to the situation graphically reproduced in FIGS. 1 and 2. The upper curves in FIG. 3 show in turn on the one hand the variation of the target mass flow \dot{m}ₙₒₘᵢₙₐₗ as a reference value over time t, which by analogy to FIGS. 1 and 2 is approximately constant and was provided as input to the regulating device depending on the vehicle speed, the desired target spreading quantity per unit area and the desired working width. On the other hand, the upper curves in FIG. 3—again by analogy to FIGS. 1 and 2—can correspond to the variation of the actuating variable y, which can correspond e.g. to the position of the actuator of a sliding metering element of the metering unit as well as the actual mass flow \dot{m}_{actual} as the controlled variable over time t (grey curve).

As can be seen from FIG. 3, the control mode according to the invention corresponds during the revolution rate change of the distribution disc (t₁<t<t₂) to that according to FIG. 2. However, the regulating algorithm illustrated in FIG. 3, as used during the regulating modes in phases of constant revolution rate, makes use of the regulating formula described above, wherein the integrating component ∫x_{d}*dt of said regulating formula is set to zero in the regulating mode (t>t₂) for the first determination of the actuating variable y_{R} that is representative of the opening position of the metering unit, such as e.g. the actuator position of a sliding metering element of the metering unit. In this way the term Y_{Radaptiv}, which on the one hand takes into account the last actuating variable yₛ of the preceding control mode, and on the other hand takes into account the last regulating deviation x_{d} (deviation of the actual mass flow \dot{m}_{actual} from the target mass flow \dot{m}ₙₒₘᵢₙₐₗ), receives increased weight, whereas on the other hand said term y_{Radaptiv} loses weight with continuing duration of the regulating mode (the regulating deviation x_{d} is smaller), whereas the integrating component ∫x_{d}*dt provides reliable values.

As shown in FIG. 3, this not only allows underfertilization or overfertilization to be reliably prevented during the occurrence of changes of the revolution rate of the distribution disc, i.e. during the time period t₁<t<t₂, which is achieved by the changeover according to the invention of the regulating mode to the control mode, but also to be reliably prevented especially if relatively lower underfertilization or overfertilization occur (in FIG. 3 underfertilization)—which are nevertheless to be avoided for reasons of plant protection, environmental protection as well as economics—because of initialization of the regulating mode following the control mode, by the regulating algorithm taking into account the actuating variable y_{R} resulting from the last control mode and—e.g. in a manner described by way of example using the above regulating formula—being highly weighted at the start of the control mode, whereas it loses weighting with continuing duration of regulation, e.g. until approximately 0, because it is increasingly compensated by the integrating component ∫x_{d}*dt (see above) of the actuating variable y_{R}.

The same applies of course to the non-graphically reproduced case in which the revolution rate of the distribution disc or of the shaft in its drive train may well remain constant, but the value of the sensor-determined controlled variable representative of the actual mass flow has temporarily fallen below a signal-to-noise ratio, which has caused a changeover from the regulating mode to the control mode, whereupon the regulating mode can be initiated in the same way and using the same regulating algorithm.

In any case it can be of advantage if an updated actuating variable representative of the opening position of the metering unit is generated, at least in the regulating mode with each computation cycle (which may reveal a change of the regulating deviation because of a sensor-recorded actual mass flow, which deviates more or less from the target mass flow compared to the previous computation cycle). The computation cycles can thereby preferably take place at very small time intervals of e.g. approximately 10 ms in order to ensure regulation of the mass flow of spreading material practically in real time.

In one development it can be provided that the current operating state (regulating or control mode) is indicated on a display device, so that the operator receives a notification regarding the respective operating modes and may intervene to carry out regulation if the control modes, which of course can only ever describe an approximation to the current actual state, get out of hand. This can be especially advantageous in the case of a mechanical drive of the disc spreader, in which the drive train of its distribution disc(s) is directly connected to a power take-off shaft of a tractor machine, such as a tractor, controlled by the operator so that the operator is enabled to avoid any driving maneuvers that cause an excessive change of revolution rate and hence a transition into the control mode and hence to ensure a spreading mode primarily in the regulating mode. For the same purpose it can equally be of advantage if the duration of the operating states in the regulating mode and in the control mode is determined and indicated on a display device.

As already mentioned, the invention is especially also suitable for disc spreaders that comprise a plurality of, especially two, distribution discs, wherein in particular a metering unit that can be regulated by means of the computer-based control device can be associated with each distribution disc in order to regulate or to control the metering units associated with the distribution discs independently of each other according to the respective requirements, which can be different on both sides (e.g. if different target mass flows of spreading material during spreading of the headland at the edge of the field are desired, while traveling on a hillside or similar).

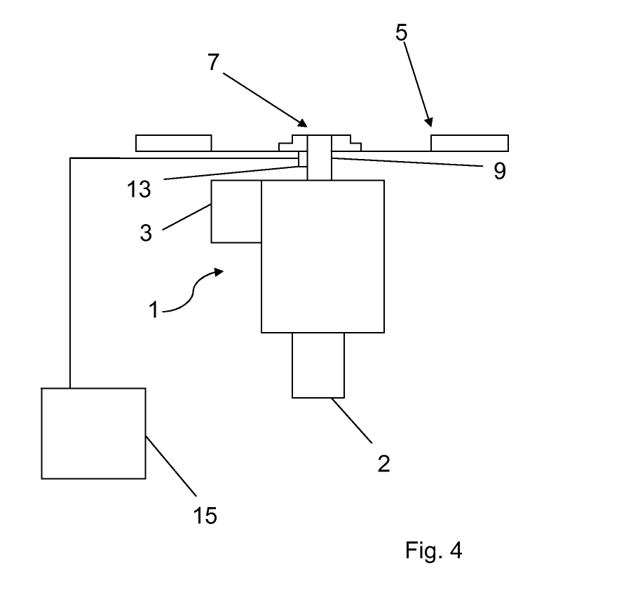

FIG. 4 is a view of a disc spreader 1. The disc spreader 1 includes at least one regulated metering unit 3 and at least one distribution disc 5. A motor 2 is provided for driving the disc spreader 1. A drive train 7 of the distribution disc 5 includes at least one shaft 9. A sensor 13 may be connected to the at least one shaft 9. Data from the sensor is provided as input to a regulating device 15. The data may include one or more of torque of the at least one shaft 9 in the drive train 7 of the distribution disc 5 and torsion of the at least one shaft 9 in the drive train 7 of the distribution disc 5.

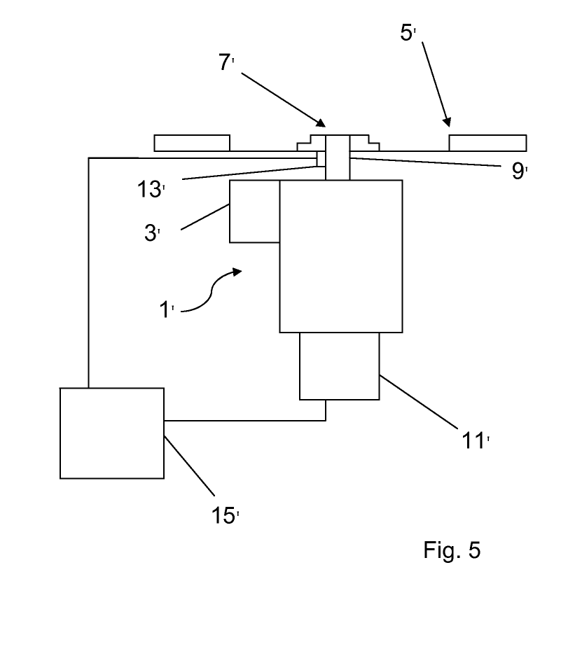

FIG. 5 is a view of another embodiment of a disc spreader 1′. The disc spreader 1′ includes at least one regulated metering unit 3′ and at least one distribution disc 5′. A hydraulic motor 11′ is provided for driving the disc spreader 1′. A drive train 7′ of the distribution disc 5′ includes at least one shaft 9′. A sensor 13′ may be connected to the at least one shaft 9′. Data from the sensor 13′ is provided as input to a regulating device 15′. The data may include one or more of torque of the at least one shaft 9′ in the drive train 7′ of the distribution disc 5′ and torsion of the at least one shaft 9′ in the drive train 7′ of the distribution disc 5′. In addition, data from the hydraulic motor 11′ may be provided as input to the regulating device 15′, including a pressure difference of the hydraulic motor 11′. Data from the sensor 13′ and/or data from the hydraulic motor 11′ may be used as a controlled variable.

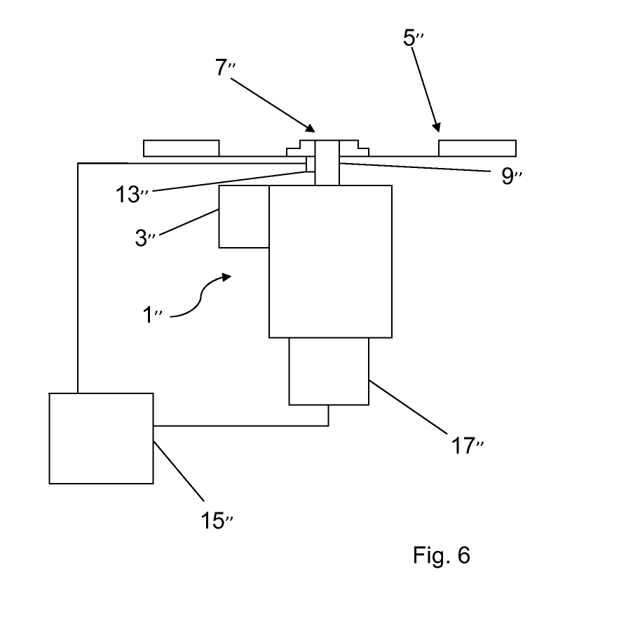

FIG. 6 is a view of another embodiment of a disc spreader 1″. The disc spreader l′ includes at least one regulated metering unit 3″ and at least one distribution disc 5″. An electric motor 17″ is provided for driving the disc spreader 1″. A drive train 7″ of the distribution disc 5″ includes at least one shaft 9″. A sensor 13″ may be connected to the at least one shaft 9″. Data from the sensor 13″ is provided as input to a regulating device 15″. The data may include one or more of torque of the at least one shaft 9″ in the drive train 7″ of the distribution disc 5″ and torsion of the at least one shaft 9″ in the drive train 7″ of the distribution disc 5″. In addition, data from the electric motor 17″ may be provided as input to the regulating device 15″, including current drain of the electric motor 17″. Data from the sensor 13″ and/or data from the electric motor 17″ may be used as a controlled variable.

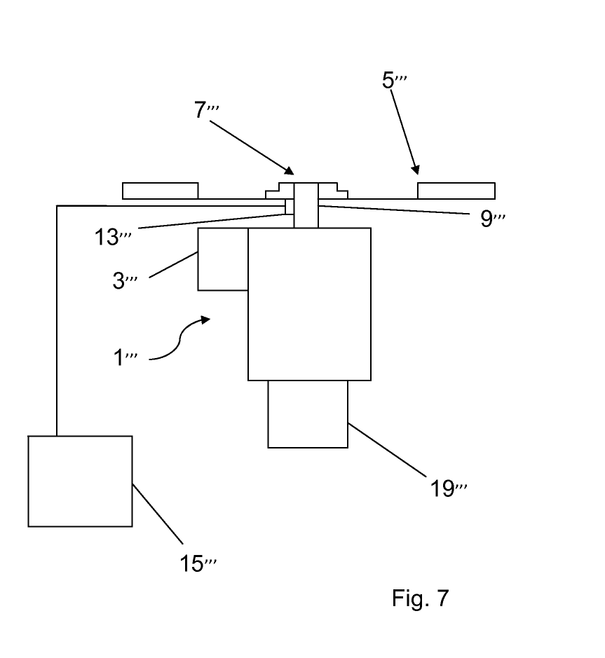

FIG. 7 is a view of another embodiment of a disc spreader 1′″. The disc spreader 1′″ includes at least one regulated metering unit 3′″ and at least one distribution disc 5′″. A drive train 7′″ of the distribution disc 5′″ includes at least one shaft 9′″, which is coupled to a power take-off shaft 19′″ of a vehicle, such as a tractor. The at least one shaft 9′″ is driven by the power take-off shaft 19′″. A sensor 13′″ may be connected to the at least one shaft 9′″. Data from the sensor 13′″ is provided as input to a regulating device 15′″. The data may include one or more of torque of the at least one shaft 9′″ in the drive train 7′″ of the distribution disc 5′″ and torsion of the at least one shaft 9′″ in the drive train 7′″ of the distribution disc 5′″. Data from the sensor 13′″ may be used as a controlled variable.

While specific embodiments of the invention have been shown and described in detail to illustrate the application of the principles of the invention, it will be understood that the invention may be embodied otherwise without departing from such principles.

What is claimed is:

1. A method for regulating an actual mass flow of spreading material of at least one regulated metering unit of a disc spreader with at least one distribution disc associated with the metering unit, the method comprising:
determining a target mass flow of spreading material based on at least one parameter, said at least one parameter corresponding to at least one of a current vehicle speed of the disc spreader, a target spreading quantity per unit area and a working width, said target mass flow being provided as input to a computer-based regulating device as a reference value, wherein at least one sensor-determined controlled variable representative of the actual mass flow is provided as input to the regulating device, said at least one sensor determined controlled variable representative of the actual mass flow corresponding to at least one of a torque of at least one shaft in a drive train of the distribution disc, a torsion of at least one shaft in a drive train of the distribution disc, a pressure difference of a hydraulic motor used to drive the distribution disc and a current drain of an electric motor used to drive the distribution disc, and a sensor-determined actual revolution rate of the distribution disc or of at least one shaft in the drive train is provided as input to the regulating device;
determining a deviation of the actual mass flow of spreading material from the target mass flow of spreading material in a regulating mode of the regulating device and generating an actuating variable representative of the opening position of the metering unit to readjust the metering unit to the target mass flow based on an actual revolution rate of the distribution disc or an actual revolution rate of the shaft in the drive train;
one of setting the regulating device into a control mode and the regulating device activating a control mode of a control device while one or more of a maximum value of changes of the sensor-determined revolution rate of the distribution discs or of the shaft in the drive train is exceeded and while a signal-to-noise ratio of the sensor-determined controlled variable representative of the actual mass flow is below a minimum value, wherein in the control mode the actuating variable representative of the opening position of the metering unit is generated independently of the sensor-determined controlled variable that is representative of the actual mass flow in order to control the metering unit of the distribution disc independently of said controlled variable.

2. A method according to claim 1, wherein one or more of the maximum value of changes of the sensor-determined revolution rate of the distribution disc or of the shaft in the drive train and the minimum signal-to-noise ratio of the sensor-determined controlled variable representative of the actual mass flow is predetermined.

3. A method according to claim 1, characterized in that at least one of a plurality of last actuating variables representative of the opening position of the metering unit is stored in the regulating mode and said actuating variable is held constant in the subsequent control mode.

4. A method according to claim 3, wherein one of said at least one last actuating variable representative of the opening position of the metering unit and an average value over a number of the last actuating variables representative of the opening position of the metering unit is stored in the regulating mode and is used for the control mode.

5. A method according to claim 1, wherein the actuating variable representative of the opening position of the metering unit is generated in the control mode based on a value representative of physical properties of the spreading material.

6. A method according to claim 5, wherein the value representative of the physical properties of the respective spreading material is a value representative of fluid properties of the spreading material.

7. A method according to claim 5, wherein at least one of the last values representative of the physical properties of the spreading material is stored in the regulating mode and the actuating variable representative of the opening position of the metering unit in the subsequent control mode is generated depending on said stored value.

8. A method according to claim 7, wherein one of the last value representative of the physical properties of the spreading material and an average value over a number of the last values representative of the physical properties of the spreading material is stored in the control mode and is used for the control mode.

9. A method according to claim 5, wherein the actuating variable representative of the opening position of the metering unit is generated based on the target mass flow used as the reference value.

10. A method according to claim 9, wherein the value representative of the physical properties of the spreading material is a reciprocal value of a flow factor, which is defined by a quotient of the target mass flow used as the reference value divided by the actuating variable representative of the opening position of the metering unit.

11. A method according to claim 1, wherein the control of the metering unit takes place in the control mode independently of the sensor-determined revolution rate of the distribution disc or of the shaft in the drive train.

12. A method according to claim 5, wherein the control of the metering unit takes place in the control mode depending on a reciprocal value of at least one of a plurality of last flow factors in the regulating mode multiplied by the target mass flow used as the reference value.

13. A method according to claim 1, wherein regulation of the actual mass flow takes place in the regulating mode using a plurality of characteristic curves stored in the control device or in a memory associated with the control device, which describe a dependency of the actual mass flow on the respective sensor-determined controlled variable representative of the actual mass flow for different revolution rates or ranges of revolution rates of the distribution disc or of the shaft in the drive train.

14. A method according to claim 1, wherein regulation of the actual mass flow takes place in the regulating mode using at least one mathematical function that describes a dependency of the actual mass flow on the respective sensor-determined, controlled variable representative of the actual mass flow and on the revolution rate of the distribution disc or of the shaft in the drive train.

15. A method according to claim 1, wherein the controlled variable representative of the actual mass flow is determined by a sensor in no-load mode with the metering unit closed and consequently with an unloaded distribution disc, wherein the distribution disc loaded by the actual mass flow in a load mode, wherein a value determined in the no-load mode is subtracted from a total value determined under load to determine a difference value caused by the actual mass flow of the spreading material alone, wherein said difference value is provided as input to the control device as the at least one sensor-determined controlled variable representative of the actual mass flow.

16. A method according to claim 15, wherein the controlled variable representative of the actual mass flow is determined by a sensor in the no-load mode at periodic time intervals.

17. A method according to claim 1, wherein the regulating device is one of set into the regulating mode again and deactivates the control mode of the control device once one or more of the maximum value of changes of the sensor-determined revolution rate of the distribution disc or of the shaft in the drive train is reached again or the changes fall below the maximum value and the minimum signal-to-noise ratio of the sensor-determined controlled variable representative of the actual mass flow of spreading material is reached again or exceeded.

18. A method according to claim 17, wherein at least for a first determination of the actuating variable representative of the opening position of the metering unit in the regulating mode, an integrating component of regulation, which integrates the deviation of the actual mass flow of spreading material from the target mass flow of spreading material over time, is set to zero after one of after resetting the regulating device into the regulating mode and after deactivation of the regulating device.

19. A method according to claim 16, wherein at least one of a plurality of last actuating variables representative of the opening position of the metering unit is stored in the control mode and said at least one stored actuating variable is added as a summary component when determining the actuating variable representative of the opening position of the metering unit in the regulating mode of the regulation after one of resetting the regulating device into the regulating mode and deactivation of the control device.

20. A method according to claim 19, wherein one of the last actuating variable in the control mode and an average value over a number of last actuating variables in the control mode is stored and is used for the regulating mode.

21. A method according to claim 19, wherein in the regulating mode a value representative of the deviation of the actual mass flow of spreading material from the target mass flow of spreading material, at a point in time during or immediately after one of resetting the regulating device into the regulating mode and deactivation of the control device, is subtracted from a summary component of the stored actuating variable from the control mode that is representative of the opening position of the metering unit and that is added to the regulation.

22. A method according to claim 1, wherein at least in the regulating mode an updated actuating variable representative of the opening position of the metering unit is generated with each computation cycle.

23. A method according to claim 1, wherein a current operating state comprises one of said regulating mode and said control mode, said current operating state being indicated on a display device.

24. A method according to claim 1, wherein durations of operating states in the regulating mode and in the control mode are determined and indicated on a display device.
